(19) United States
(12) Patent Application Publication
(10) Pub. No.: US 2025/0362926 A1
(43) Pub. Date: Nov. 27, 2025

(54) OPERATION CONTROL METHOD AND ELECTRONIC DEVICE

(71) Applicant: Lenovo (Beijing) Limited, Beijing (CN)

(72) Inventors: Weiwei WANG, Beijing (CN); Jie WANG, Beijing (CN)

(21) Appl. No.: 19/216,681

(22) Filed: May 22, 2025

(30) Foreign Application Priority Data
May 23, 2024 (CN) 202410649980.1

(51) Int. Cl. G06F 9/4401; G05B 15/02

(52) U.S. Cl. CPC G06F 9/4401; G05B 15/02

(57) ABSTRACT

An operation control method includes: in the process of an electronic device running a target application, in response to a target triggering event, launching a first target service model, where the first target service model is configured to provide a target functional service; monitoring the adaptation value between the first target service model and the target application; and, when the adaptation value changes to fall within a target threshold range, controlling the electronic device to switch from running the first target service model to launching a second target service model, where the quality of the functional service provided by the second target service model is better than that of the first target service model, and/or the user experience of the second target service model is better than that of the first target service model.

### CROSS-REFERENCE TO RELATED APPLICATION

This application claims priority to Chinese Patent Application No. 202410649980.1, filed on May 23, 2024, the content of which is incorporated herein by reference in its entirety.

### TECHNICAL FIELD

The application generally relates to the field of computer technology, and in particular to an operation control method and a device thereof.

### BACKGROUND

In the related technology, different applications are equipped with intelligent assistants during operation. These intelligent assistants are generally fixed in different usage scenarios of the applications. This leads to inaccurate strategies provided by the intelligent assistants or waste of the intelligent assistants' resources during the operation of the applications, thereby worsening the user experience.

### SUMMARY

One embodiment of the present disclosure provides an operation control method, and the method includes: in the process of an electronic device running a target application, in response to a target triggering event, launching a first target service model for providing a target functional service; monitoring the adaptation value between the first target service model and the target application; and, when the adaptation value changes to fall within a target threshold range, controlling the electronic device to switch from running the first target service model to launching a second target service model, where the quality of the functional service provided by the second target service model is better than that of the first target service model, and/or the user experience of the second target service model is better than that of the first target service model.

Another embodiment of the present disclosure provides an electronic device. The electronic device includes one or more processors and a memory containing a computer program that, when being executed, causes the one or more processors to perform: in a process of an electronic device running a target application, in response to a target triggering event, launching a first target service model, the first target service model being configured to provide a target functional service; monitoring an adaptation value between the first target service model and the target application; and when the adaptation value changes to fall within a target threshold range, controlling the electronic device to switch from running the first target service model to launching a second target service model. A quality of a functional service provided by the second target service model is better than a quality of a functional service provided by the first target service model, and/or a user experience of the second target service model is better than a user experience of the first target service model.

Another embodiment of the present disclosure provides a non-transitory computer readable storage medium containing a computer program that, when being executed, causes at least one processor to perform: in a process of an electronic device running a target application, in response to a target triggering event, launching a first target service model, the first target service model being configured to provide a target functional service; monitoring an adaptation value between the first target service model and the target application; and when the adaptation value changes to fall within a target threshold range, controlling the electronic device to switch from running the first target service model to launching a second target service model. A quality of a functional service provided by the second target service model is better than a quality of a functional service provided by the first target service model, and/or a user experience of the second target service model is better than a user experience of the first target service model.

It should be understood that the above summary and the following detailed description are merely exemplary and explanatory, and are not intended to limit the technical solutions of the present disclosure. Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solutions in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flow chart of an operation control method, according to some embodiments of the present disclosure;

FIG. 2 is a flow chart of another operation control method, according to some embodiments of the present disclosure;

FIG. 3 is a flow chart of another operation control method, according to some embodiments of the present disclosure;

FIG. 4 is a flow chart of another operation control method, according to some embodiments of the present disclosure;

FIG. 5 is a flow chart of a method for using an auto-sorting model, according to some embodiments of the present disclosure;

FIG. 6 is a schematic diagram of the system architecture of an operation control device, according to some embodiments of the present disclosure; and

FIG. 7 is a schematic diagram of an electronic device, according to some embodiments of the present disclosure.

### DETAILED DESCRIPTION

In order to make the objective, technical solutions and advantages of the present disclosure clearer, the technical solutions of the present disclosure are further elaborated in detail hereinafter in conjunction with the accompanying drawings and specific embodiments. The described embodiments should not be regarded as limiting the present disclosure. All other embodiments obtained by a person skilled in the art without making creative efforts still fall within the scope of protection of the present disclosure.

In the following descriptions, reference is made to “some embodiments”, which describe a subset of all possible embodiments, but it is understood that “some embodiments” may be the same subset or different subsets of all possible embodiments, and may be combined with each other without conflict. The terms “first/second/third” are merely used to distinguish similar objects and do not indicate a specific order for the objects. It is understood that “first/second/third” may be interchanged in a specific order or sequence where permitted, so that the embodiments of the present disclosure described herein may be implemented in an order other than those illustrated or described herein.

Unless otherwise defined, technical and scientific terms used herein have the same meaning as those commonly understood by those skilled in the art to which the present disclosure belongs. The terms used herein are merely for the purpose of describing the present disclosure and are not intended to limit the disclosure.

In the existing technologies, different applications are equipped with intelligent assistants during operation, but the intelligent assistants equipped for applications in different usage scenarios are fixed. This leads to inaccurate services provided by the intelligent assistants and waste of the intelligent assistants' resources during the operation of the applications, thereby worsening the user experience.

Based on the above technical problems, the embodiments of the present disclosure provide an operation control method, which may be executed by a processor of an electronic device. The electronic device may be a server, a laptop, a tablet, a desktop computer, a smart TV, a set-top box, a mobile device (such as a mobile phone, a portable video player, a personal digital assistant, a dedicated messaging device, a portable gaming device, etc.) and other devices with data processing capabilities.

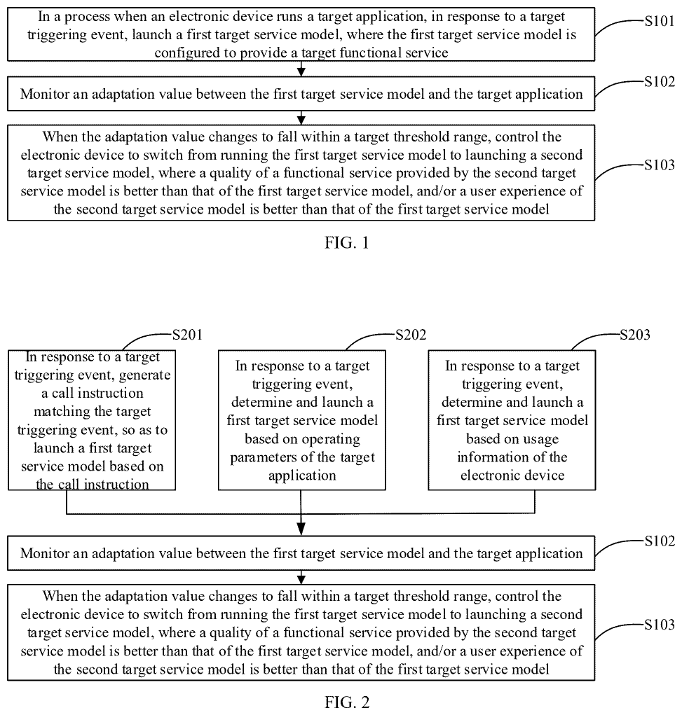

FIG. 1 is a flow chart of an operation control method, according to some embodiments of the present disclosure. As shown in FIG. 1, the method includes the following Steps S101 to S103, which will be described in conjunction with the steps shown in FIG. 1.

Step S101: In a process when an electronic device runs a target application, in response to a target triggering event, launch a first target service model, where the first target service model is configured to provide a target functional service.

In some embodiments, the electronic device may be a laptop, a desktop computer, a smart phone, a smart watch, a tablet, a smart home appliance, a game console, a DVD player, a television, etc.

In some embodiments, the target application may be a game application (which may be competitive, script-based, card-based, development-based, etc.), an office application (e.g., word processing software, spreadsheet processing software, database software, etc.), a social application (which may be for phone calls, text messages, or video application, etc.), an entertainment application (which may be for film and television, music, shopping, etc.), etc.

In some embodiments, the process of the electronic device running the target application may include the target application being started, the target application having just started, and the target application having started for a little while.

In some embodiments, the target triggering event may include detection that a user has left the operable range of an electronic device, a user has not operated the device for a little while, a user has issued a hosting command, a user has entered a multi-person chat mode (e.g., voice chat, video chat, text chat, etc.), a user is a new user, the target application is interrupted by other applications (such as phone access, video access, conference access, alert, alarm information, etc.), or a user switches the target application to the background, etc.

In some embodiments, the first target service model may be a pre-trained few-shot user behavior model, a proxy model for learning a user's own behavior, a big data model for collecting all user behaviors, etc.

In some embodiments, the first target service model may be a model for different application scenarios, such as a conference assistance model, a call assistance model, a social assistance model, a game assistance model, an office assistance model, etc.

In some embodiments, the target function service may be a service that takes over game operations from a user, a service that performs calculations, analysis, decision-making, beautification and other operations on behalf of a user, a service that imitates a user to interact with other users (which may be in the telephone communication, video communication, text communication, etc.), a service that provides a shopping plan for a user, a service that provides a travel route for a user, etc.

In some embodiments, the target function service provided by the first target service model may also be to optimize the user experience of the target application or to improve the response speed of an associated application of the target application, or to enhance or optimize a certain function of the target application. For example, if the target application is a competitive game and the first target service model is a game assistance model, then the target function service provided by the first target service model may be to take over a user's operation or to enhance a certain operation of the user. It is to be noted that, for competitive games, the target function service may be to provide a user with equipment matching strategies or to improve the hit rate of the user, etc.

In some embodiments, during a process of the electronic device running the target application, in response to a target triggering event, a first target service model is launched, and the first target service model is configured to provide a target function service. For example, during the process of the electronic device running the target application, a target triggering event may be a first type of triggering event, a second type of triggering event, etc. A first type or second type of first target service model is determined according to the first type of triggering event or the second type of triggering event. A first type of target function service or a second type of target function service is provided to the user according to the first type or the second type of first target service model.

Exemplarily, an embodiment of the present disclosure is described by taking an electronic device as a desktop computer, a target application as a card game, running the target application as a card game for a little while, and a target triggering event as detecting that the user has left the operational range of the electronic device as an example. It may be understood that during the process of the desktop computer running the card game for a little while, it is detected that the user has left the operational range of the desktop computer, and the game assistance model is launched to take over the user's next card-playing operation, where the game assistance model may be a pre-trained few-shot user behavior model or a proxy model for learning a user's own behavior or a big data model for collecting all user behaviors corresponding to the game assistance model.

Step S102: Monitor an adaptation value between the first target service model and the target application.

In some embodiments, the adaptation value between the first target service model and the target application refers to the adaptation parameter between the first service model and the real-time operating environment of the target application. The adaptation value also indicates user adaptability of the first service model. The adaptation value may be understood as a comprehensive score based on various indicators such as running speed, accuracy, user approval rate, difficulty of continuous parameter adjustment, Turing test misjudgment index, and the like for the first target service model in the real-time operating environment of the target application.

In some embodiments, the adaptation value between the first target service model and the target application is monitored. For example, the running speed of the first target service model in different target application environments, the Turing test misjudgment index, the difficulty of continuous parameter adjustment, and the user approval rate and accuracy of the target function service provided by the first target service model within a preset time period are monitored. The adaptation value between the first target service model and the target application is obtained based on the running speed of the first target service model in different target application environments, the Turing test misjudgment index, the difficulty of continuous parameter adjustment, the user approval rate, accuracy, etc.

Step S103: When the adaptation value changes to fall within a target threshold range, control the electronic device to switch from running the first target service model to launching a second target service model, where a quality of a functional service provided by the second target service model is better than that of the first target service model, and/or a user experience of the second target service model is better than that of the first target service model.

In some embodiments, the target threshold range may include threshold range intervals corresponding to different models. For example, the target threshold range may be a threshold range interval corresponding to the adaptation value of the first target service model or a threshold range interval corresponding to the adaptation value of the second target service model, where the threshold range interval corresponding to the adaptation value of the first target service model and the threshold range interval corresponding to the adaptation value of the second target service model may be the same or different.

Exemplarily, the threshold range interval corresponding to the adaptation value of the first target service model is 7 to 9, and the threshold range interval corresponding to the adaptation value of the second target service model is 5 to 8. In another example, the threshold range interval corresponding to the adaptation value of the second target service model may also be 7 to 9.

In some embodiments, the target threshold range may also be a range of adaptation value differences between models of a set of models in a target service model set. For example, the target threshold range may be a threshold interval of the difference between the adaptation values of the first target service model and the second target service model. In other words, the target threshold range is a change threshold range for the adaptation value of each model, in the set of models, that may be changed in the current time period.

Exemplarily, the adaptation value of the first target service model is 5, the adaptation value of the second target service model is 9, and the model switching is performed when the threshold interval of the difference between the adaptation values of the first target service model and the second target service model is greater than or equal to 3. As can be seen, the difference between the adaptation value of the first target service model and the adaptation value of the second target service model is 4. Since 4 is within the difference threshold interval, the first target service model with an adaptation value of 5 is controlled to switch to a second target service model with an adaptation value of 9.

In some embodiments, the quality of the functional service provided by the second target service model is better than that of the first target service model. For example, after switching the first target service model to the second target service model, the adaptation performance of the second target service model is better than that of the first target service model. For example, the running speed, operating accuracy, user approval rate, and Turing test misjudgment index of the second target service model may be better than those of the first target service model.

In some embodiments, the user experience of the second target service model is better than that of the first target service model. For example, after switching the first target service model to the second target service model, the user experience of the second target service model is better than that of the first target service model. For example, the rating, user approval rate, accuracy, and response speed of the second target service model may be better than those of the first target service model.

In the embodiments of the present disclosure, in an operating process of a target application on an electronic device, a first target service model is launched based on a user's target triggering event. The first target service model may provide the user with a target service function. After the first target service model runs for a little while, the adaptation value between the first target service model and the target application is obtained in the real-time environment. The first target service model is switched when the adaptation value is changed to fall within a target threshold range. In this way, the operating model of the target application may be dynamically switched according to the real-time adaptation value of the target service model, so that the target application maintains a high level of usage, thereby improving the user experience.

FIG. 2 is a flow chart of another operation control method provided by the embodiments of the present disclosure, which may be executed by a processor of an electronic device. Based on FIG. 1, Step S101 in FIG. 1 may be updated to Step S201 or Step S202 or Step S203, which will be described in conjunction with the steps shown in FIG. 2.

Step S201: In response to the target triggering event, generate a call instruction matching the target triggering event, so as to launch the first target service model based on the call instruction.

In some embodiments, the call instruction for the target triggering event may be a generation of a call instruction for a game hosting, a call instruction for automatic answer, a call instruction for audio and video beautification, etc.

In some embodiments, in response to a target triggering event, a call instruction matching the target triggering event is generated to launch the first target service model based on the call instruction. For example, according to target triggering events for different application scenarios or different types of target triggering events, call instructions for different application scenarios or different types of target triggering events are generated, and first service models for different application scenarios or different types of target triggering events are called based on the call instructions for different application scenarios or different types of target triggering events.

Exemplarily, when the target triggering event is a game hosting event, a corresponding call instruction for game hosting is generated, and a game hosting service model is launched based on the call instruction for game hosting. When the target triggering event is a call access event, a corresponding call instruction for automatic answer is generated, and a corresponding automatic answer service model is launched based on the call instruction for automatic answer. When the target triggering event is a multi-person chat event, a corresponding call instruction for a smart reply service is generated, and the corresponding smart reply service model is launched based on the call instruction for a smart reply service.

Step S202: In response to the target triggering event, determine and launch the first target service model based on operating parameters of the target application.

In some embodiments, the operating parameters may indicate the operating stage of the target application. Illustratively, taking the target application as a game as an example, the operating stage of the game may indicate the game just started, the game in the progress, the game already ended, etc.

In some embodiments, the operating parameters may further indicate the operating state of the target application. Illustratively, also taking the target application as a game as an example, the operating state of the game may indicate the operating time of the game, the operating flow of the game, the operating level of the game, etc.

In some embodiments, the operating parameters may further indicate the operating type of the target application. For example, still taking the target application as a game as an example, the operating type of the game may indicate whether the game is a stand-alone game, an online game, a single-player operation, a two-player operation, etc.

In some embodiments, in response to the target triggering event, the first target service model is determined and launched based on the operating parameters of the target application. In other words, according to target triggering events in different application scenarios or different types of target triggering events, the corresponding first target service model is determined and launched based on different operating stages of the target application, or the corresponding first target service model is determined and launched based on different operating states of the target application, or the corresponding first target service model is determined and launched based on different operating types of the target application.

Exemplarily, the embodiments of the present disclosure are explained by taking the target application as a competitive game, the target triggering event as detecting a user having left an operable range of the competitive game, and the operating parameters of the target application as the operating stage of the target application as an example. It may be understood that when the operating stage of the competitive game is just started, a pre-trained few-shot user behavior model corresponding to a game assistance model is determined as the first target service model, and thus the pre-trained few-shot user behavior model corresponding to the game assistance model is launched. When the operating stage of the competitive game is in the process of the game, a proxy model for learning a user's own behavior corresponding to the game assistance model is determined as the first target service model, and the proxy model for learning a user's own behavior corresponding to the game assistance model is launched. When the operating stage of the competitive game is at the end of the game, a big data model for collecting all user behaviors corresponding to the game assistance model is determined as the first target service model, and the big data model for collecting all user behaviors is launched.

Exemplarily, the embodiments of the present disclosure are described by taking the target application as a competitive game, the target triggering event as detecting the user having left the operable range of the competitive game, and the operating parameters of the target application as the operating state of the target application as an example. It may be understood that when the operating state of the competitive game is poor operating fluency, a pre-trained few-shot user behavior model corresponding to the game assistance model is determined and launched as the first target service model. When the operating state of the competitive game is normal operating fluency, a proxy model for learning the user's own behavior corresponding to the game assistance model is determined and launched as the first target service model. When the operating state of the competitive game is good operating fluency, a proxy model for learning the user's own behavior corresponding to the game assistance model or a big data model for collecting all user behaviors is determined and launched as the first target service model.

Exemplarily, the embodiments of the present disclosure are described by taking the target application as a competitive game, the target triggering event as detecting the user having left the operable range of the competitive game, and the operating parameters of the target application as the operating type of the target application as an example. It may be understood that when the operating type of the competitive game is a stand-alone game, a pre-trained few-shot user behavior model corresponding to the game assistance model or a proxy model for learning a user's own behavior is determined and launched as the first target service model. When the operating type of the competitive game is an online game, a pre-trained few-shot user behavior model or a proxy model for learning a user's own behavior or a big data model for collecting all user behaviors, corresponding to the game assistance model, is determined and launched as the first target service model.

Step S203: In response to the target triggering event, determine and launch the first target service model based on usage information of the electronic device.

In some embodiments, the usage information of the electronic device may indicate the function and resource usage information of the electronic device. The usage information of the electronic device may include user information of the electronic device (which may include the number of users, personal information of each user, behavior data of each user, etc.), model usage information of the electronic device (which may include memory usage of the electronic device, energy performance preference (EPP) of the electronic device, bandwidth of the electronic device, refresh rate of the electronic device, etc.), and operating mode information of the electronic device (which may include stand-alone operation of the electronic device, online operation, interconnection with other electronic devices, etc.).

In some embodiments, in response to the target triggering event, the first target service model is determined and launched based on usage information of the electronic device. In other words, according to target triggering events in different application scenarios or different types of target triggering events, based on user information, model usage information, and operating mode information of the electronic device, the first target service model is determined and launched as a pre-trained few-shot user behavior model, or a proxy model for learning a user's own behavior, or a big data model for collecting all user behaviors.

Exemplarily, the embodiments of the present disclosure are described by taking the target application as a card game, and the target triggering event as a detection of entering the hosting state as an example. It may be understood that, in the case where the usage information of the electronic device is user information, the behavior data corresponding to the user is obtained according to the user information of the electronic device. A proxy model for learning a user's own behavior for a game assistance model corresponding to the user behavior data is determined and launched as a first target service model based on the user's behavior data. In the case where the usage information of the electronic device is model usage information, if the memory of the electronic device is occupied by a large amount (e.g., the occupancy is greater than 80%) and the energy performance preference of the electronic device is large, a pre-trained few-shot user behavior model of the game assistance model is determined and launched as the first target service model. If the memory of the electronic device is occupied by a small amount (e.g., the occupancy is less than 30%), a proxy model for learning a user's own behavior of the game assistance model or a big data model for collecting all user behaviors is determined and launched as the first target service model. In the case where the usage information of the electronic device is the operating mode information, if the operating mode information is a stand-alone operation, a pre-trained few-shot user behavior model or a proxy model for learning a user's own behavior for a game assistance model corresponding to the user behavior data is determined and launched as the first target service model. If the operating mode information is an online operation, a pre-trained few-shot user behavior model or a proxy model for learning a user's own behavior for a game assistance model corresponding to the user behavior data is determined and launched as the first target service model. If the operating mode information is an interconnection with other electronic devices, a pre-trained few-shot user behavior model or a proxy model for learning a user's own behavior or a big data model for collecting all user behaviors for a game assistance model corresponding to the user behavior data is determined and launched as the first target service model.

In the embodiments of the present disclosure, an optimal first target service model in the current target application real-time environment is determined based on the call instruction of the target triggering event, the operating parameters of the target application, and the usage information of the electronic device, thereby improving the model's adaptability to the current target application real-time environment and the user experience.

In some embodiments, the above Step S201 may be implemented by the following implementations.

In response to a first type of triggering event that triggers the target application to enter a hosting state, a first call instruction is generated, to launch a corresponding first service model from a first service model set based on the first call instruction.

In some embodiments, the hosting state may indicate a state where a user does not perform any input, or a state where the device or application enters an automatic operating state without any user involvement.

In some embodiments, the hosting state for the first type of triggering event may include a game hosting state, a call hosting state, a multi-person chat hosting state, etc.

In some embodiments, the first call instruction is configured to determine a service model set corresponding to the first type of triggering event.

In some embodiments, the first service model set may indicate a model library or model pool applied to the hosting type, where the model library or model pool of the hosting type may include a pre-trained few-shot user behavior model or a proxy model for learning a user's own behavior or a big data model for collecting all user behaviors for the game hosting type, a pre-trained few-shot user behavior model or a proxy model for learning a user's own behavior or a big data model for collecting all user behaviors for the call hosting type, etc.

In some embodiments, the method of launching the corresponding first service model may include launching a first service model based on the model identifier carried by a call instruction, launching a first service model based on the score of each service model in a model library or model pool, launching a corresponding first service model based on historical data of the target application, launching a first service model based on the resource status of the electronic device, launching a first service model based on the type or source of the target triggering event, etc.

In some embodiments, in response to a first type of triggering event that triggers the target application to enter the hosting state, a first call instruction is generated to launch a corresponding first service model from a first service model set based on the first call instruction. For example, in response to the target applications such as a game or call entering a hosting state, a first call instruction is generated, and a service model set corresponding to the target application such as the game or call application entering the hosting state is determined according to the first call instruction. A first service model is launched according to a model identifier carried by the first call instruction, a score of each service model in the model library or model pool, historical data of the target application, a resource status of the electronic device, and a type or source of the target triggering event.

Exemplarily, in response to the game entering the hosting state, a first call instruction corresponding to the game hosting is generated. According to the first call instruction corresponding to the game hosting, a pre-trained few-shot user behavior model or a proxy model for learning a user's own behavior or a big data model for collecting all user behaviors of the game hosting service model corresponding to the game hosting is determined. Based on the identifier of the pre-trained few-shot user behavior model or the proxy model for learning a user's own behavior or the big data model for collecting all user behaviors carried by the first call instruction, the pre-trained few-shot user behavior model or the proxy model for learning a user's own behavior or the big data model for collecting all user behaviors is launched. Alternatively, a service model with the highest score among the pre-trained few-shot user behavior model or the proxy model for learning a user's own behavior or the big data model for collecting all user behaviors is launched. Alternatively, if the game is launched for the first time, the pre-trained few-shot user behavior model is launched. If there is user historical hosting data, the proxy model for learning a user's own behavior is launched or the big data model for collecting all user behaviors is launched. Alternatively, when the resource usage of the electronic device is large, the pre-trained few-shot user behavior model is launched. When the resource usage of the electronic device is small, the proxy model for learning a user's own behavior or the big data model for collecting all user behaviors is launched. Alternatively, if the game hosting comes from the user, the proxy model for learning a user's own behavior or the big data model for collecting all user behaviors is launched. If the game hosting comes from the monitoring of the user having left the operable range of the game, the pre-trained few-shot user behavior model or the proxy model for learning a user's own behavior or the big data model for collecting all user behaviors is launched.

In response to a second type of triggering event that triggers the target application to execute a target task, a second call instruction is generated to launch a second service model, from a second service model set, that matches the target task based on the second call instruction, where the target task comes from the target application or its associated application.

In some embodiments, the target task may include performing calculations, analysis, decision-making, beautification, imitating services of users to interact with other users (such as calling, chatting, social networking), etc.

In some embodiments, the second type of triggering event may include a multi-player chat mode, a new player, a phone call, a conference call, etc.

In some embodiments, the second call instruction is used to determine a service model set corresponding to the second type of triggering event, that is, a second service model set.

In some embodiments, the second service model set includes a game service model set, a call service model set, a conference service model set, a multi-person chat service model set, etc.

In some embodiments, matching the target task may include matching the type of the target task, matching the task content of the target task, and the like.

In some embodiments, other associated applications may include applications that obtain or call related functions, or applications that have an associated relationship at a certain moment. For example, if a call prompt or message pop-up window is obtained during a game, the game application and the application that sends the message may be associated.

In some embodiments, in response to a second type of triggering event that triggers the target application to perform a target task, a second call instruction is generated to launch a second service model, from a second service model set, that matches the target task based on the second call instruction, where the target task comes from the target application or its associated application. For example, in response to the target application performing calculations, analysis, decisions, beautification, imitation of multi-person chat mode, new players, telephone access, conference access, etc., a second call instruction is generated, to determine a second service model from a game service model set corresponding to the multi-person chat mode, new player, telephone access, and conference access, a voice (or call) service model set, a conference service model set, a multi-person chat service model set, etc. According to the second call instruction, a second service model corresponding to the type or content of the second service model set is matched from the services including calculation, analysis, decision-making, beautification, and imitation through which users interact with other users (such as calls, chats, social networking, etc.).

Exemplarily, the embodiments of the disclosure are described by taking the second type of triggering event being a call access and the target task being interaction with other users as an example. It may be understood that a second call instruction for call access is generated, and a call service model set is determined from second service model sets including a game service model set, a call service model set, a conference service model set, a multi-person chat service model set, and the like based on the second call instruction for call access. Based on an example of the target task being interaction with other users, a proxy model for learning a user's own behavior or a big data model for collecting all user behaviors in the call service model set is launched.

In the embodiments of the present disclosure, a corresponding call instruction is generated according to a triggering event of a target application, and a corresponding service model is determined and launched from a service model set according to the call instruction, thereby improving the accuracy of applying the model to the triggering event of the target application and improving the user experience.

In some embodiments, the above-described process of generating the first call instruction in response to the first type of triggering event that triggers the target application to enter the hosting state, so as to launch the corresponding first service model from the first service model set based on the first call instruction may be implemented through the following: based on the model identifier carried by the first call instruction, the first service model is launched from the first service model set.

In some embodiments, the model identifier carried by the first call instruction indicates that the first call instruction carries a pre-trained few-shot user behavior model or a proxy model for learning a user's own behavior or a big data model for collecting all user behaviors corresponding to a game service model, a call service model, a conference service model, or a multi-person chat service model, etc.

In some embodiments, based on the model identifier carried by the first call instruction, the first service model is launched from the first service model set. For example, based on the first call instruction carrying a pre-trained few-shot user behavior model or a proxy model for learning a user's own behavior or a big data model for collecting all user behaviors corresponding to a game service model, call service model, conference service model, multi-person chat service model, etc., a first service model is launched from the game service model set, call service model set, conference service model set, or multi-person chat service model set.

Exemplarily, based on the first call instruction carrying the identifier of a pre-trained few-shot user behavior model corresponding to a hosted game service model, the pre-trained few-shot user behavior model corresponding to the hosted game service model is launched from the game service model set. Based on the first call instruction carrying the identifier of a proxy model for learning a user's own behavior corresponding to a call service model, the proxy model for learning a user's own behavior corresponding to the call service model is launched from the voice (or call) service model set.

In response to a first call instruction generated based on the first type of triggering event, based on the score of each service model in the first service model set, a first service model in the target score range is launched from the first service model set.

In some embodiments, the first call instruction carrying the score of each service model includes a first call instruction carrying a game service model score of 8, a first call instruction carrying a call service model score of 7, a first call instruction carrying a conference service model score of 7, and a first call instruction carrying a multi-person chat service model score of 9.

In some embodiments, in response to a first call instruction generated based on the first type of triggering event, based on the score of each service model in the first service model set, a first service model in the target score range is launched from the first service model set. For example, based on the first call instruction carrying the game service model score of 8, a game service model with a score of 8 is launched from the game service model set. Based on the first call instruction carrying the call service model score of 7, a call service model with a score of 7 is launched from the call service model set. Based on the first call instruction carrying the conference service model score of 7, a conference service model with a score of 7 is launched from the conference service model set. Based on the first call instruction carrying the multi-person chat service model score of 8, a multi-person chat service model with a score of 8 is launched from the multi-person chat service model set.

In response to a first call instruction generated based on the first type of triggering event, the first service model is launched from the first service model set based on historical operating data of the target application.

In some embodiments, the target application may include a game application, a call application, a conference application, a multi-person chat application, etc.

In some embodiments, the historical data of the target application may include whether the target application is launched for the first time, whether the target application has player historical data, etc.

In some embodiments, in response to a first call instruction generated based on the first type of triggering event, the first service model is launched from the first service model set based on the historical operation data of the target application. For example, when a game application, a call application, a conference application, a multi-person chat application, etc., is launched for the first time, a first service model is launched from the game service model set, the call service model set, the conference service model set, and the multi-person chat service model set. Exemplarily, when a game application is launched for the first time, a pre-trained few-shot user behavior model is launched from the game service model set. When the game application has player historical data, a proxy model for learning a user's own behavior or a big data model for collecting all user behaviors is launched from the game service model set.

In response to a first call instruction generated based on the first type of triggering event, the first service model is launched from the first service model set based on the resource usage status of the electronic device.

In some embodiments, the resource usage status of the electronic device includes whether the resources of the electronic device are largely occupied (e.g., more than 80%) or slightly occupied (e.g., less than 30%).

In some embodiments, in response to a first call instruction generated based on the first type of triggering event, the first service model is launched from the first service model set based on the resource usage status of the electronic device. For example, when the electronic device resources carried by the first call instruction are occupied in a large amount or in a small amount, the first service model is launched from the game service model set, the call service model set, the conference service model set, the multi-person chat service model set, etc.

Exemplarily, when the electronic device resources carried by the first call instruction are occupied in a large amount, a pre-trained few-shot user behavior model corresponding to a game service model, call service model, conference service model, or multi-person chat service model is launched from the game service model set, call service model set, conference service model set, or multi-person chat service model set. When the electronic device resources carried by the first call instruction are occupied in a small amount, a proxy model for learning a user's own behavior or a big data model for collecting all user behaviors corresponding to a game service model, call service model, conference service model, and multi-person chat service model is launched from the game service model set, call service model set, conference service model set, or multi-person chat service model set.

Based on the type and/or source of the first triggering event, the first service model is launched from the first service model set.

Here, the type of first triggering event includes at least one of the following: detecting that the target operator has a first position relationship with the electronic device, detecting that no operation command is obtained within a first time period, obtaining a target hosting command, and obtaining an instruction to switch the target application to background operation.

In some embodiments, the first position relationship indicates a position relationship between a user and the operable range of the target application, for example, the user has left the operable range of the target application.

In some embodiments, failure to obtain an operation instruction within a first time period may indicate that the user has not manipulated the target application within the first time period.

In some embodiments, the target hosting command may indicate a hosting command issued by the user through a specific control or button, or by voice or gesture.

In some embodiments, switching the target application to the background may indicate that the user minimizes the target application, drags the target application to another screen, or covers the target application with other windows.

In some embodiments, based on the type and/or source of the first triggering event, the first service model is launched from the first service model set. For example, according to the first call instruction corresponding to a user having left the operable range of the target application, the user not running the target application within a first period of time, the user issuing a hosting command through a specific control or button, voice or gesture, minimizing the target application, dragging the target application to other screens to run, or covering the target application with other windows, a first service model is launched from the game service model set, the call service model set, the conference service model set, or the multi-person chat service model set.

Exemplarily, according to a first call instruction indicating that the carried user has left the operable range of a game application, a proxy user operation model is launched from the game service model set. Based on a first call instruction indicating that the carried user has not operated a multi-person chat application within a first period of time, an automatic reply service model is launched from the multi-person chat service model set. Based on a first call instruction indicating a carried hosting command issued by voice or gesture, an automatic answer service model is launched from a call service model set.

In the embodiments of the present disclosure, the first service model is launched from the first service model set through the model identifier carried by the first call instruction, the score of each service model, the historical data of the target application, the resource usage status of the electronic device, and the type and/or source of the first triggering event, thereby improving the accuracy of the service model in different environments of the target application and improving the user experience.

In some embodiments, the above Step S202 may be implemented through the following implementations.

Based on the operating stage of the target application, a third service model matching the operating stage is determined and launched from the third service model set.

In some embodiments, the operating stage of the target application may include the target application just launched or the target application launched for a little while. Illustratively, taking a game as an example, the operating stage of the game may include the game just launched, the game still in progress, the game already ended, etc.

In some embodiments, the third service model set includes a game service model set, a call service model set, a multi-person chat service model set, etc.

In some embodiments, the third service model may be a small model, a medium model or a large model. A small model is preferred at the beginning or end of a game. For a small model, it may be determined whether to select a few-shot model or a model trained based on historical data based on whether the application is run for the first time or the N-th time.

In some embodiments, based on the operating stage of the target application, a third service model matching the operating stage is determined and launched from a third service model set. For example, when the operating state of the target application is just launched, a small model from a model set such as a game service model set, a call service model set, or a multi-person chat service model set is determined and launched as the third service model. Here, the small model may be a pre-trained few-shot user behavior model. When the operating state of the target application is launched for a little while, a small model, a medium model, or a large model is launched from a model set such as a game service model set, a call service model set, or a multi-person chat service model set. Here, the medium model refers to a proxy model for learning a user's own behavior, and the large model refers to a big data model for collecting all user behaviors.

Exemplarily, taking the target application as a game, the operating stage of the game indicating that the game has started for a little while, including in the middle of the game and the end of the game as an example. It may be understood that when the operating stage of the game is when the game is just launched, a pre-trained few-shot user behavior model is launched from a game assistance model set. When the operating stage of the game is during a game, a proxy model for learning a user's own behavior or a big data model for collecting all user behaviors is launched from a game assistance model set. When the operating stage of the game is at the end of a game, a pre-trained few-shot user behavior model is launched from a game assistance model set.

Based on the operation mode of the target application, a fourth service model matching the operation mode is determined and launched from a fourth service model set.

In some embodiments, the operation mode of the target application may include a stand-alone operation, online operation, single-person operation, two-person operation, etc.

In some embodiments, the fourth service model set may include a game service model set, a voice service model set, and the like.

In some embodiments, based on the operation mode of the target application, a fourth service model matching the operation mode is determined and launched from a fourth service model set. For example, when the operation mode of the target application is a stand-alone mode or a single-player operation, from the model sets such as a game service model set, a voice service model set, etc., a pre-trained few-shot user behavior model corresponding to a model set such as a game service model set or a voice service model set is determined as the fourth service model and launched. When the operation mode of the target application is an online mode or a two-player operation, from model sets such as a game service model set, a voice service model set, etc., a proxy model for learning a user's own behavior or a big data model for collecting all user behaviors corresponding to a model set such as a game service model set, a voice service model set, etc., is determined as the fourth service model and launched.

Embodiments of the disclosure are illustrated by taking the target application as a game as an example. For example, when the operating type of the game is a stand-alone game or a single-player operation, a pre-trained few-shot user behavior model corresponding to a game service model is launched from the game service model set. When the operation mode of the game is an online game or a two-player operation, a proxy model for learning a user's own behavior or a big data model for collecting all user behaviors corresponding to a game service model is launched from the game service model set.

Based on operation evaluation information of the target operator for the target application, a fifth service model matching the operation evaluation information is determined and launched from a fifth service model set.

In some embodiments, the target application's operating evaluation information may indicate the target application's operating time, operating flow, target application's operating difficulty, user's mood, and the like.

In some embodiments, a fifth service model set may include a game service model set, a voice service model set, and other model sets.

In some embodiments, based on the target operator's operation evaluation information for the target application, a fifth service model matching the operation evaluation information is determined and launched from the fifth service model set. For example, when the operation evaluation information of the target application is the target application's operating time, operating flow, target application operating difficulty, and user mood, a pre-trained few-shot user behavior model or a proxy model for learning a user's own behavior or a big data model for collecting all user behaviors, corresponding to a game service model set, voice service model set and other model sets, is determined and launched as the fifth service model.

Embodiments of the present disclosure are illustrated by taking the target application as a game as an example. For example, when the game's operating evaluation information relates to operating smoothness, if the operating smoothness is low, a pre-trained few-shot user behavior model is launched from the game service model set. If the operating smoothness is high, a proxy model for learning a user's own behavior or a big data model for collecting all user behaviors is launched from the game service model set. When the game's operating evaluation information relates to operating duration, if the operating duration is short, a pre-trained few-shot user behavior model is launched from the game service model set. If the operating duration is long, a proxy model for learning a user's own behavior or a big data model for collecting all user behaviors is launched from the game service model set. When the game's operating evaluation information relates to operating difficulty, if the game operating difficulty is simple, a pre-trained few-shot user behavior model is launched from the game service model set. If the game operating difficulty is difficult, a proxy model for learning a user's own behavior or a big data model for collecting all user behaviors is launched from the game service model set.

In some embodiments, the above Step S203 may be implemented by the following implementations.

Based on function and resource usage information of the electronic device, a sixth service model matching the function and resource usage information is determined and launched from a sixth service model set.

In some embodiments, the function and resource usage information of the electronic device may include the memory occupancy of the electronic device, the energy performance preference of the electronic device, the bandwidth of the electronic device, the refresh rate of the electronic device, etc.

In some embodiments, the sixth service model set may include a game service model set, a voice service model set, and other model sets.

In some embodiments, based on the function and resource usage information of the electronic device, a sixth service model matching the function and resource usage information is determined and launched from the sixth service model set. For example, the sixth service model is launched from a model set such as a game service model set, a voice service model set, etc., according to the memory usage of the electronic device, the energy performance preference of the electronic device, the bandwidth of the electronic device, and the refresh rate of the electronic device.

Exemplarily, the function and resource usage information of the electronic device takes the energy performance preference of the electronic device as an example, and the target application takes a game as an example to illustrate the embodiments of the present disclosure. For example, when the energy performance preference of the electronic device is relatively low (e.g., less than 16), it may support the operation of any model, and thus a pre-trained few-shot user behavior model or a proxy model for learning a user's own behavior or a big data model for collecting all user behaviors is selected and launched from the game service model set. When the energy performance preference of the electronic device is relatively large (e.g., greater than 128), it may merely support the operation of small models or medium models, and thus only a pre-trained few-shot user behavior model or a proxy model for learning a user's own behavior is launched from the game service model set.

Based on user information of the electronic device, a seventh service model matching the user information is determined and launched from a seventh service model set.

In some embodiments, the user information of the electronic device may include the number of users of the electronic device, personal information of each user, behavioral data of each user, etc.

In some embodiments, the seventh service model set may include a game service model set, a voice service model set, a conference service model set, and other model sets.

In some embodiments, based on the user information of the electronic device, a seventh service model matching the user information is determined and launched from the seventh service model set. For example, according to the number of users of the electronic device, the personal information of each user, and the behavior data of each user, a corresponding seventh service model is launched from the game service model set, the voice service model set, or the conference service model set.

Exemplarily, in the case where the user information is the number of users of the electronic device, when the number of users is multiple (e.g., more than 5 people), it may be determined that the current target application scenario is a conference scenario, and a conference assistance model is launched from the conference service model set. When the number of users is small (e.g., 1 to 2 people), it may be determined that the current target application scenario is a game scenario, and a game assistance service model is launched from the game service model set. In the case where the user information is the user's personal information, the historical models used by the user in different scenarios are obtained, and the historical model used by the user in a scenario is launched according to the scenario of the user's target application. For example, in a voice scenario, the historical model used by the user is an automatic answering service model, then the automatic answering service model is launched from the voice service model set.

Based on model usage information of the electronic device, an eighth service model matching the model usage information is determined from the eighth service model set and launched.

In some embodiments, the model usage information of the electronic device indicates whether the models corresponding to the electronic device in different environments are occupied, the usage frequency of different models in the same environment, etc.

In some embodiments, the eighth service model may include a game service model set, a voice service model set, and other model sets.

In some embodiments, based on the model usage information of the electronic device, an eighth service model matching the model usage information is determined and launched from the eighth service model set. For example, an eighth service model is launched from model sets such as the game service model set and the voice service model set according to whether the models corresponding to the electronic device in different environments are occupied, the usage frequency of different models in the same environment, etc.

Embodiments of the present disclosure are illustrated by taking the usage frequency of different models of the electronic device in the same environment as an example of the function and resource usage information of the electronic device and by taking a game as an example of the target application. It may be understood that the electronic device may adopt multiple different service models in the same environment. For example, for the game environment, a hosting service model or an auxiliary attack service model may be adopted. The usage frequency of the hosting service model is 5 times, and the usage frequency of the auxiliary attack service model is 10 times, then the auxiliary attack service model is launched from the game service model set.

Based on operating mode information of the electronic device, a ninth service model matching the operating mode information is determined and launched from a ninth service model set.

In some embodiments, the operating mode information of the electronic device may include the electronic device operating as a stand-alone operation, an online operation, or an interconnection with other electronic devices.

In some embodiments, the ninth service model may include a game service model set, a voice service model set, and other model sets.

In some embodiments, based on the operating mode information of the electronic device, a ninth service model matching the operating mode information is determined and launched from a ninth service model set. According to the operating mode information of the electronic device, which may include the electronic device operating as a stand-alone operation, an online operation, or an interconnection with other electronic devices, a ninth service model is launched from a model set such as a game service model set, a voice service model set, etc.

Exemplarily, when the operating mode information of the electronic device is a stand-alone operation, a pre-trained few-shot user behavior model corresponding to the game service model set, voice service model set, etc., is launched from the model sets such as the game service model set and the voice service model set. When the operating mode information of the electronic device is an online operation, a pre-trained few-shot user behavior model or a proxy model for learning a user's own behavior corresponding to a game service model set, voice service model set, etc., is launched from the model sets such as the game service model set and the voice service model set. When the operating mode information of the electronic device is an interconnection with other electronic devices, a proxy model for learning a user's own behavior or big data model for collecting all user behaviors corresponding to a game service model set, voice service model set, etc., is launched from the model sets such as the game service model set and the voice service model set.

In the embodiments of the present disclosure, a service model is determined based on the operating parameters of the target application and the usage information of the electronic device, thereby improving the accuracy of the service model.

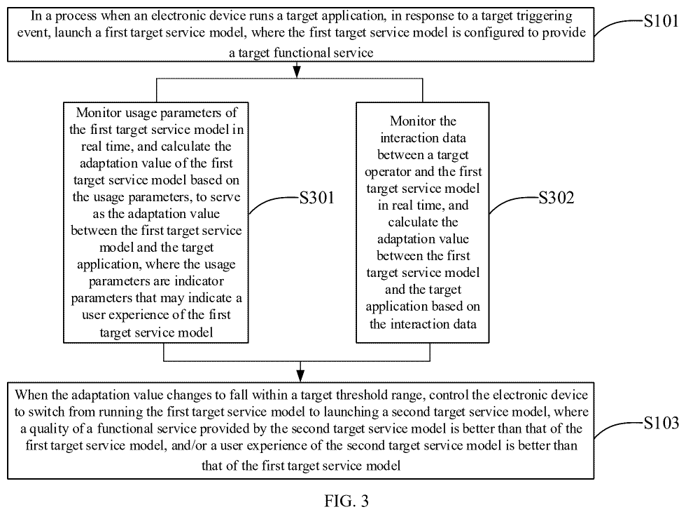

FIG. 3 is a flow chart of another operation control method provided by the embodiments of the present disclosure, which may be executed by a processor of an electronic device. Based on FIG. 1, Step S102 in FIG. 1 may be updated to Step S301 or Step S302, which will be described in conjunction with the steps shown in FIG. 3.

Step S301: Monitor usage parameters of the first target service model in real time, and calculate the adaptation value of the first target service model based on the usage parameters, to serve as the adaptation value between the first target service model and the target application, where the usage parameters are indicator parameters that may indicate a user experience of the first target service model.

In some embodiments, the usage parameters of the first target service model may include a running speed P1 of substituting the actual data of the target application into the first target service model (reflecting the difficulty of the model, which relates to the hardware of the user's electronic device), an accuracy P2 of the first target service model in the current usage scenario, a difficulty P3 of continuous parameter adjustment of the first target service model, a user approval rate P4 for the performance of the first target service model, and a user's Turing test misjudgment index P5 of the model.

In some embodiments, the adaptation value of the first target service model is calculated based on the usage parameters, to serve as the adaptation value between the first target service model and the target application. For example, for the current usage scenario, a pre-trained few-shot user behavior model, a proxy model for learning a user's own behavior, and a big data model for collecting all user behaviors included in the first target service model are automatically selected and segmented using the analytical hierarchy process (AHP), and a three-layer architecture of the target layer, the middle layer, and the bottom layer is adopted. The analytical hierarchy process refers to a decision-making method that decomposes the elements that are related to the decision into levels such as goals, criteria, and plans, and conducts qualitative and quantitative analysis on this basis. This method was proposed by American operations researcher professor Satie of the University of Pittsburgh in the early 1970s when he was studying the topic of “power distribution according to the contribution of various industrial sectors to national welfare” for the US Department of Defense. He applied network system theory and multi-objective comprehensive evaluation methods to a hierarchical weight decision analysis method.

In the embodiments of the present disclosure, the bottom layer refers to the pre-trained few-shot user behavior model M1, the proxy model for learning a user's own behavior M2, and the big data model for collecting all user behaviors M3. The middle layer refers to the running speed P1 of each model at the bottom layer, the user's accuracy P2 of the first target service model, the difficulty P3 of continuous parameter adjustment, the user approval rate P4 for the first target service model, and the user's Turing test misjudgment index P5 for the first target service model. The target layer refers to a selection of the most appropriate service model from the service models at the bottom layer.

In some embodiments, according to the middle layer P1, P2, P3, P4, and P5, an expert scoring method is used to set a judgment matrix B, and the judgment matrix B is shown in Table 1.

TABLE 1

| B | P1 | P1 | P1 | P1 | P1 |
|---|---|---|---|---|---|
| P1 | 1 | ½ | ¼ | ⅙ | ⅕ |
| P2 | 2 | 1 | ⅗ | ⅓ | ½ |
| P3 | 4 | 5/3 | 1 | ½ | ½ |
| P4 | 6 | 3 | 2 | 1 | 2 |
| P5 | 5 | 2 | 2 | ½ | 1 |

In some embodiments, the pre-trained few-shot user behavior model, the proxy model for learning a user's own behavior, and the big data model for collecting all user behaviors are respectively substituted into P1, P2, P3, P4, and P5 to generate a middle layer matrix. In the embodiments of the present disclosure, taking the pre-trained few-shot user behavior model M1, the proxy model for learning a user's own behavior M2, and the big data model for collecting all user behaviors M3 as an example, which are substituted into P1 to generate a middle layer matrix as shown in Table 2.

TABLE 2

| P1 | M1 | M2 | M3 |
|---|---|---|---|
| M1 | 1 | ½ | 5 |
| M2 | 2 | 1 | 12 |
| M3 | ⅕ | 1/12 | 1 |

In some embodiments, the product-sum method is used to calculate the maximum eigenvector W of the judgment matrix B. For example, each column element of the judgment matrix B is normalized to obtain the general term of the element as shown in Formula (1).

$${b}_{ij} = \frac{{b}_{ij}}{{\sum }_{1}^{n} {b}_{ij}} ( i , j = 1 , 2 , 3 , 4 , 5 ) \qquad ( 1 )$$

where each column element of the judgment matrix B is normalized to obtain the general term bᵢⱼ of each element, n is the order of the matrix, i indicates the number of rows of the matrix, and j indicates the number of columns of the matrix. In the embodiments of the present disclosure, n takes a value of 5, and the normalized judgment matrix B′ is shown in Table 3.

TABLE 3

| B′ | P1 | P1 | P1 | P1 | P1 |
|---|---|---|---|---|---|
| P1 | 0.056 | 0.061 | 0.067 | 0.048 | 0.275 |
| P2 | 0.111 | 0.122 | 0.133 | 0.119 | 0.587 |
| P3 | 0.222 | 0.204 | 0.2 | 0.119 | 0.916 |
| P4 | 0.333 | 0.367 | 0.4 | 0.476 | 1.918 |
| P5 | 0.278 | 0.246 | 0.2 | 0.238 | 0.304 |

In some embodiments, the sum of the last column of the normalized judgment matrix B′ is normalized to obtain the maximum eigenvector W of the judgment matrix B, as shown in Table 4.

TABLE 4

| | W |
|---|---|
| W 1 | 0.055 |
| W 2 | 0.1174 |
| W 3 | 0.1832 |
| W 4 | 0.3836 |
| W 5 | 0.2608 |

According to Table 4, the maximum eigenvector W of the judgment matrix B=(W1, W2, W3, W4, W5)^{t}=(0.055,0.1174,0.1832,0.3836,0.2608)′, where W1 indicates that the weight of P1 is 0.55, W2 indicates that the weight of P2 is 0.1174, W3 indicates that the weight of P3 is 0.1832, W4 indicates that the weight of P4 is 0.3836, and W5 indicates that the weight of P5 is 0.2608.

In some embodiments, the judgment matrix B and the maximum eigenvector of the judgment matrix B are multiplied to obtain (BW)=(0.2726, 0.5956, 0.9211, 1.9538, 1.3288), and the maximum eigenroot of the judgment matrix B is obtained based on BW, as shown in Formula (2).

$${λ}_{m ax} = {\sum }_{1}^{n} \frac{{( BW )}_{j}}{{nW}_{j}} \approx 5.06 \qquad ( 2 )$$

where λₘₐₓ indicates the maximum eigenvalue of the judgment matrix B.

In some embodiments, the consistency index of the judgment matrix B is calculated based on the maximum eigenvalue of the judgment matrix B, as shown in Formula (3).

$$CI = \frac{{λ}_{ma x} - n}{n - 1} = \frac{5.06 - 5}{5 - 1} = 0.015 \qquad ( 3 )$$

where CI is the consistency index of the judgment matrix B.

In some embodiments, the random consistency ratio of the judgment matrix B is calculated according to the consistency index of the judgment matrix B, as shown in Formula (4).

$$CR = \frac{C . I .}{R . I .} = \frac{0.015}{1.12} \approx 0.013 \qquad ( 4 )$$

where CR is the random consistency ratio of the judgment matrix B, and R.I. is the consistency index of matrices of different orders, which may be directly obtained by looking up the table, corresponds to the order, and is a fixed value. In the embodiments of the present disclosure, R.I. takes a value of 5.

In some embodiments, if CR is less than 0.10, it indicates that the judgment matrix has acceptable consistency. In the embodiments of the present disclosure, CR is equal to 0.013, which is less than 0.10. This indicates that the judgment matrix B has acceptable consistency.

In some embodiments, the maximum eigenvectors of the middle layers P1, P2, P3, P4, and P5 for the target layer are respectively obtained. For example, the maximum eigenvectors of the middle layers P1, P2, P3, P4, and P5 are calculated using the product-sum method, as shown in Table 5.

TABLE 5

| | | |
|---|---|---|
| W₁¹ | W₂¹ | W₃¹ |
| W₁² | W₂² | W₃² |
| W₁³ | W₂³ | W₃³ |
| W₁⁴ | W₂⁴ | W₃⁴ |
| W₁⁵ | W₂⁵ | W₃⁵ |

In some embodiments, for the bottom-level pre-trained few-shot user behavior model M1, proxy model for learning a user's own behavior M2, and big data model for collecting all user behaviors M3, a fitness formula is used to calculate the fitness values of M1, M2, and M3, as shown in Formula (5).

$${S}_{k} = \sum {W}_{j} * {W}_{j}^{k} , k = ( 1 , 2 , 3 ) \qquad ( 5 )$$

where Sₖ is the adaptation value of the model. According to Formula (5), S₁ corresponding to the pre-trained few-shot user behavior model M1, S₂ corresponding to the proxy model for learning a user's own behavior M2, and S₃ corresponding to the big data model for collecting all user behaviors M3 are calculated.

In some embodiments, the maximum value among S₁, S₂, and S₃ is used as the adaptation value between the target application and the model.

Step S302: Monitor the interaction data between a target operator and the first target service model in real time, and calculate the adaptation value between the first target service model and the target application based on the interaction data.

In some embodiments, the interaction data may include the degree of repetition of user input data, the response speed of the model, etc.

In some embodiments, the interaction data between the target operator and the first target service model is monitored in real time, and the adaptation value between the first target service model and the target application is calculated based on the interaction data. For example, the repetition degree of the target operator's input data between the target operator and the first target service model and the response speed of the model and so on are monitored in real time. The adaptation value between the first target service model and the target application is calculated based on the repetition degree of the target operator's input data and the response speed of the model.

Exemplarily, in the case where the interaction data is the repetition degree of the target operator's input data, if the first target service model is a pre-trained few-shot user behavior model M1, when it is detected that the target operator repeatedly asks the same question, the scoring weight of the pre-trained few-shot user behavior model M1 will be reduced. That is, the adaptation value between the pre-trained few-shot user behavior model and the target application will be reduced. At this time, the model will be replaced with a proxy model for learning a user's own behavior M2 or big data model for collecting all user behaviors M3. If it is detected that the target operator asks progressive questions, the pre-trained few-shot user behavior model M1 will continue to be used. In the case where the interaction data is the response speed of the model, if the first target service model is a proxy model for learning a user's own behavior M2 or big data model for collecting all user behaviors M3, a time threshold is set, such as 30S (obtained through user surveys, etc.). The response speed of the proxy model for learning a user's own behavior M2 or the big data model for collecting all user behaviors M3 is obtained according to the number of times the first target service model answers questions within the time threshold. If the proxy model for learning a user's own behavior M2 or the big data model for collecting all user behaviors M3 responds slowly (much slower than the response speed of the first target service model that is a pre-trained few-shot user behavior model M1), it means that the adaptation value between the proxy model for learning a user's own behavior M2 or the big data model for collecting all user behaviors M3 and the target application is low. At this time, the first target service model is switched to the pre-trained few-shot user behavior model M1.

In the embodiments of the present disclosure, the adaptation value between the first target service model and the target application is calculated based on the usage parameters of the first target service model and the interaction data between the target operator and the first target service model, and the first target service model is switched based on the adaptation value, so that the service model of the target application continues to operate at a high level, thereby improving the accuracy of the model and user experience.

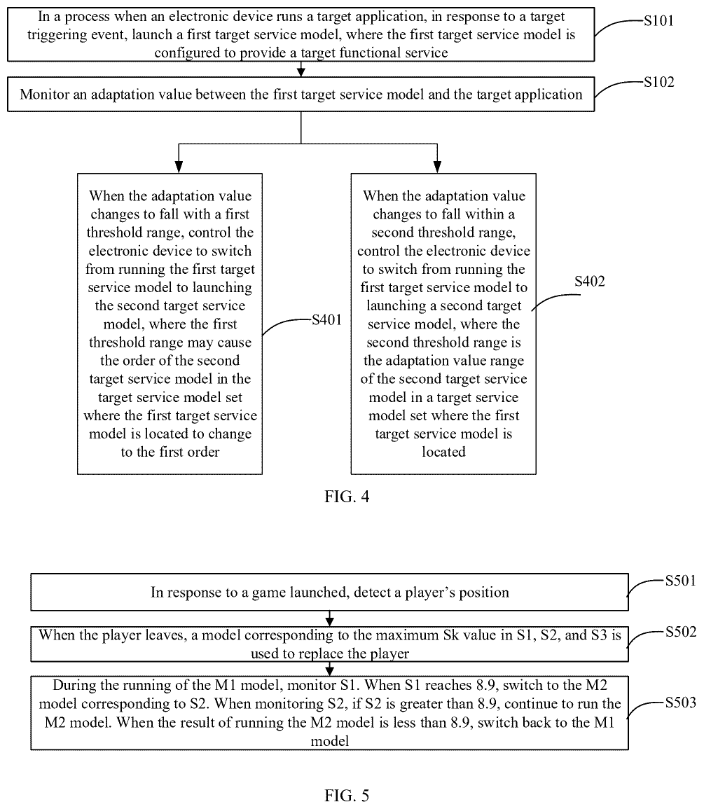

FIG. 4 is a flow chart of another operation control method provided by the embodiments of the present disclosure, which may be executed by a processor of an electronic device. Based on FIG. 1, Step S103 in FIG. 1 may be updated to Step S401 or Step S402, which is described in conjunction with the steps shown in FIG. 7.

Step S401: When the adaptation value changes to fall with a first threshold range, control the electronic device to switch from running the first target service model to launching the second target service model, where the first threshold range may cause the order of the second target service model in the target service model set where the first target service model is located to change to the first order.

In some embodiments, the first threshold range may include threshold range intervals corresponding to different models. For example, the first threshold range may be a threshold range interval corresponding to the adaptation value of the first target service model and a threshold range interval corresponding to the adaptation value of the second target service model, where the threshold range interval corresponding to the adaptation value of the first target service model and the threshold range interval corresponding to the adaptation value of the second target service model may be the same or different.

In some embodiments, when the adaptation value changes to fall within a first threshold range, the electronic device is controlled to switch from running the first target service model to launching the second target service model. For example, when the adaptation value of the first target service model changes to be smaller than the adaptation value of each service model in a set of other service models except the first target service model, the first target service model is switched to a service model with the largest adaptation value in the set of other service models.

Exemplarily, the adaptation value of the first target service model is 6, and the adaptation values of the set of other service models except the first target service model are all greater than 6. For example, in the set of other service models, the second target service model is 9, the third target service model is 8, the fourth target service model is 8, etc., the first target service model with an adaptation value of 6 is then switched to the second target service model with an adaptation value of 9.

In some embodiments, the first threshold range may also be a difference range of the adaptation value difference between the first target service model and each service model in the set of other service models except the first target service model. For example, the first threshold range may be a threshold interval of the difference between the adaptation values of the first target service model and the second target service model, that is, a change threshold range that may change the order of the adaptation value of each model in the current time period.

In some embodiments, when the adaptation value changes to fall within a first threshold range, the electronic device is controlled to switch from running the first target service model to launching the second target service model. For example, when the difference between the adaptation value of the first target service model and the adaptation value of any service model in a set of other service models other than the first target service model falls within a first preset range, the first target service model is switched to this service model.

Taking the first threshold range (i.e., the difference between the adaptation value of the first target service model and each service model in the set of other service models) greater than 3 as an example. In the case that the adaptation value of the first target service model is 5, and in the set of other service models, the adaptation value of the second target service model is 9, the adaptation value of the third target service model is 8, and the adaptation value of the fourth target service model is 7. The adaptation value difference between the first target service model and the second target service model is 4, the adaptation value difference between the first target service model and the third target service model is 3, and the adaptation value difference between the first target service model and the fourth target service model is 2. Since the adaptation value difference between the first target service model and the second target service model is 4, which falls within a threshold range of greater than 3, the first target service model with an adaptation value of 5 will be switched to the second target service model with an adaptation value of 9.

Step S402: When the adaptation value changes to fall within a second threshold range, control the electronic device to switch from running the first target service model to launching a second target service model, where the second threshold range is the adaptation value range of the second target service model in a target service model set where the first target service model is located.

In some embodiments, the second threshold range may indicate adaptation value ranges for different service models.

In some embodiments, when the adaptation value changes to fall within a second threshold range, the electronic device is controlled to switch from running the first target service model to launching the second target service model. For example, when the adaptation value of the first target service model drops outside the adaptation value range of the first target service model, the first target service model is switched to a service model, whose adaptation value is within the corresponding adaptation value range, in a set of other service models other than the first target service model.

Exemplarily, the adaptation value of the first target service model is 7, and the adaptation value range for the first target service model is 8 to 10, the adaptation value of the second target service model is 6, and the adaptation value range of the second target service model is 5 to 8, the adaptation value of the third target service model is 3, and the adaptation value range of the third target service model is 1 to 5, then the first target service model with the adaptation value of 7 is switched to the second target service model with the adaptation value of 6.

In the embodiments of the present disclosure, the service model of the electronic device is controlled to switch according to the adaptation value of the first target service model, the adaptation value range of the first target service model, the adaptation values of other service models other than the first target service model, and the adaptation value ranges of other service models, so as to ensure that the service model of the electronic device is continuously in a high-level working state, thereby improving the accuracy of the service model and the user experience.

In some embodiments, the above Step S402 may be implemented by the following implementations.

When it is detected that the adaptation value of the second target service model changes to fall within a third threshold range, the electronic device is controlled to switch from running the second target service model to launching the first target service model or the third target service model, where the third threshold range may cause the order of the first target service model or the third target service model in the target service model set to change to the first order.

In some embodiments, the third threshold range may be a threshold range interval corresponding to different models, or a difference range for the difference between the adaptation value of the second target service model and the adaptation value of each service model in a set of other service models except the second target service model.

In some embodiments, when it is detected that the adaptation value of the second target service model changes to fall within a third threshold range, the electronic device is controlled to switch from running the second target service model to launching the first target service model or the third target service model. For example, when it is detected that the adaptation value of the second target service model changes to fall within a threshold range interval corresponding to different models, or within a difference range of the adaptation value difference between the second target service model and each service model in the set of other service models except the second target service model, the electronic device is controlled to switch from running the second target service model to launching the first target service model or the third target service model.

In one example, the third threshold range is a threshold range interval corresponding to different models, and the threshold range intervals corresponding to different models may be the same or different. If the threshold range intervals corresponding to different models are different, in the case that the adaptation value of the first target service model is 6, and the adaptation value range of the first target service model is 3 to 7, the adaptation value of the second target service model is 7, and the adaptation value range of the second target service model is 8 to 10, and the adaptation value of the third target service model is 4, and the adaptation value range of the third target service model is 1 to 5. It can be seen that the adaptation value of the second target service model is smaller than the adaptation value range of the second target service model, and the adaptation values of the first target service model and the third target service model are in their corresponding adaptation value ranges. The second target service model is switched to the first target service model with the larger adaptation value between the first target service model and the third target service model.

In another example, the third threshold range is the difference range of the adaptation value difference between the second target service model and each service model in the set of other service models except the second target service model, and the difference range is greater than 3. In the case that the adaptation value of the first target service model is 8, the adaptation value of the second target service model is 5, and the adaptation value of the third target service model is 9, the difference between the adaptation value of the first target service model and the adaptation value of the second target service model is 3, which is not within the difference range. The difference between the adaptation value of the second target service model and the adaptation value of the third target service model is 4, which is within the difference range. Then, the second target service model with an adaptation value of 5 is switched to the third target service model with an adaptation value of 9.

In some embodiments, the above Step S103 may be implemented by the following implementations.

Obtain usage parameter change information of the first target service model, and based on the usage parameter change information, determine a tenth service model, from a target service model set where the first target service model is located, as the second target service model, so that the electronic device switches from running the first target service model to launching the tenth service model.

In some embodiments, the usage parameter change information is to substitute the actual data of the target application into the running speed P1 of the first target service model, the accuracy P2 of the first target service model in the current usage scenario, the difficulty P3 of continuous parameter adjustment of the first target service model, the user approval rate P4 for the performance of the first target service model, and the user's Turing test misjudgment index P5 of the model.

In some embodiments, the first target service model is a pre-trained few-shot user behavior model, and the second target service model is a proxy model for learning a user's own behavior or a big data model for collecting all user behaviors. P2, P4, P5 of the first target service model are not much different from P2, P4, P5 of the second target service model. At this time, the advantages of the first target service model P1, P3 are obvious, and the first target service model is used. However, when P2, P4, P5 of the first target service model are much smaller than P2, P4, P5 of the second target service model, the advantages of the first target service model P1, P3 are not so obvious, the proxy model for learning a user's own behavior or the big data model for collecting all user behaviors is used as the eleventh service model, and the first target service model is switched to the eleventh service model.

Based on the interaction data between the target operator and the first target service model and the usage parameter change information of the first target service model, the eleventh service model is determined from the target service model set as the second target service model, so that the electronic device switches from running the first target service model to launching the eleventh service model.

In some embodiments, the first target service model is a pre-trained few-shot user behavior model, and the second target service model is a proxy model for learning a user's own behavior or a big data model for collecting all user behaviors. When it is detected that the user keeps asking the first target service model the same question, it indicates that P2, P4, and P5 of the first model are small, then the proxy model for learning a user's own behavior or the big data model for collecting all user behaviors is used as the eleventh service model, and the first target service model is switched to the eleventh service model so that the electronic device runs the eleventh service model.

An exemplary application of the operation control method provided by the embodiments present disclosure is described below in a real application scenario.

The main objective of high-end gaming laptops launched these days is to stack hardware configurations, and they have not gotten out of the misunderstanding that “hardware resources are what game enthusiasts care about most.” Gaming laptops should not only have the basic configuration of gaming laptops, but also have intimate services for gaming laptops, such as customized high-end software services. This proposal takes script-murder and other script-based and card-based games as an example. The hardware performance does not necessarily need to reach the top level, but there is a real need for intelligent software services. For games such as script-murder, three kingdoms killing, tractor, and fighting the landlord, users may need to take time out to answer the phone or go to the bathroom while playing games. The existing scenarios are basically program-hosted, and the active card-playing operation is basically automatically playing a card from small to large, or randomly playing a card from left to right, etc. At this time, an AI model is needed to take over the player's next operation.

The problem is that the actual results produced by each model under different conditions are inconsistent. Some small models may produce inaccurate results, while large models may have too high hardware requirements and cannot be used universally. Smart assistants in office and learning scenarios also encounter similar problems. For example, if a call for a model is not smart enough, the speed of answering questions by the smart assistant on some models may be too slow, or the answers may be too absurd and worthless. At this time, the requirement for automatic adjustment of the model is more urgent. Therefore, there is an urgent need for an algorithm that automatically selects the appropriate model and automatically adjusts the call of a model in a timely manner.

Based on the above problems, in the game scenario, the backup solution may include using a virtual player to participate in a game and take over the role of a player who has left or gets disconnected in the middle of the game, ensuring the game experience of the remaining players and the level preservation of the player's own account. The selection of the model is determined by the adaptive auto-sorting model to help the player pick the most suitable model to take over the game. The intelligent assistant in the office scenario and the learning scenario uses the auto-sorting model to automatically match the most suitable model through multi-dimensional evaluation on different machines, so as to spit out the best response. The core idea of the auto-sorting model is to evaluate the quality of a model according to the response results of the model, so as to correct or replace the model to be loaded later. The correct selection of the model is jointly evaluated by the relevant parameters of the model itself and the output values of the subsequent responses, and then the model to be loaded next time is automatically decided. Under the initial conditions, the few-shot model M1 is used first. When the data collected by the model meets the requirements for generating its own proxy model, a self-data model M2 is added to the model selection pool. When a cloud big data model training is completed, the cloud big data model M3 is also added to the model selection pool. The local laptop or desktop computer makes continuous model correction and replacement throughout the life cycle according to the corresponding parameters of the five indicators P and the output values after operating the models. Here, P1 is the operation speed after the actual data is substituted into the model (reflecting the difficulty of the model) (related to the user's PC hardware). P2 is the accuracy of the model in the current usage scenario. P3 is the difficulty of continuous parameter adjustment of the model. P4 is the user approval rate of the model performance. P5 is the user's Turing test misjudgment index of the model. Keeping the few-shot model M1 may gradually enlarge the difference between the user and the model results, and indicators such as P2 and P4 will deteriorate. When the response performance is not good, M2 or M3 will be considered (the specific model selection comes from the calculation results of the auto-sorting model). When keeping using the self-data model M2, in the initial stage (the training data of the user proxy model is small, such as when the user just starts to play the game), indicators such as P2 and P5 may deteriorate due to the narrowness and singleness of the self-data. When the response performance is not good, M1 or M3 will be considered (the specific model selection comes from the calculation results of the auto-sorting model). When keeping using the cloud big data model M3, the performance requirements are higher, and indicators such as P1 and P3 will deteriorate. When the response performance is not good, M1 or M2 will be considered (the specific model selection comes from the calculation results of the auto-sorting model). Therefore, dynamically evaluating each relevant parameter and the final output model adaptation values will keep the software at a high level of use.

The specific implementation process of the embodiments of the disclosure is as follows.

In some embodiments, according to the present usage scenario, N preset models are automatically selected and sorted. The automatic model sorting adopts the AHP, and adopts a three-layer architecture of target layer-middle layer-bottom layer. The target layer is to select the most appropriate data operation model. The middle layer is recorded as 5 indicators, namely P1, P2, P3, P4, and P5. P1 is the operation speed after the actual data is substituted into the model (related to the user's PC hardware). P2 is the accuracy of the model in the current usage scenario. P3 is the difficulty of continuous parameter adjustment of the model (the weights of these three parameters will change in a game because the actual data will increase). P4 is the user approval rate of the performance of the model. P5 is the user's Turing test misjudgment index for the model (the weights of P4 and P5 need to be obtained by user feedback, and these weights are obtained using the previous data). According to the middle layer P1, P2, P3, P4, and P5, the judgment matrix B is set by users (at the beginning, the expert analysis method and the scoring method are used to fill in the values, and these values remain unchanged after filling in). The judgment matrix B of user A and judgment matrix B of user B are the same and remain unchanged. The judgment matrix B is shown in Table 2.

In some embodiments, the three preset models are respectively substituted into P1, P2, P3, P4, and P5 to generate the middle layer. The middle layer matrix is shown in Table 2.

In some embodiments, the maximum eigenvector W of the judgment matrix B is calculated using the product-sum method. For example, each column element of the judgment matrix B is normalized, as shown in Formula (1). After each column element of the judgment matrix B is normalized, a judgment matrix B′ is obtained, as shown in Table 3.

In some embodiments, the sum of the last column of the judgment matrix B′ is normalized to obtain the maximum eigenvector W of the judgment matrix B. As shown in Table 4, the maximum eigenvector W of the judgment matrix B=(W1, W2, W3, W4, W5)^{t}=(0.055,0.1174,0.1832,0.3836,0.2608)′, where W1 indicates that the weight of P1 is 0.55, W2 indicates that the weight of P2 is 0.1174, W3 indicates that the weight of P3 is 0.1832, W4 indicates that the weight of P4 is 0.3836, and W5 indicates that the weight of P5 is 0.2608.

In some embodiments, BW is obtained according to the judgment matrix B and the maximum eigenvector W.

In some embodiments, the maximum eigenvalue of the judgment matrix B is calculated based on BW. As shown in Formula (2), the maximum eigenvalue of the judgment matrix B is 5.06.

In some embodiments, the consistency index of the judgment matrix B is calculated based on the maximum eigenvalue, as shown in Formula (3), and the consistency index of the judgment matrix B is 0.015.

In some embodiments, the random consistency ratio of the judgment matrix B is calculated based on the consistency index of the judgment matrix B. As shown in Formula (4), the random consistency ratio of the judgment matrix B is 0.013. Since it is less than 0.10, the judgment matrix B has acceptable consistency.

In some embodiments, the maximum eigenvectors of the five solution layers for the target layer are calculated respectively, as shown in Table 5.

In some embodiments, based on the maximum eigenvector of the target layer and the maximum eigenvector of the judgment matrix B, S₁, S₂, and S₃ of M1, M2, and M3 are respectively calculated based on Formula (5), and the model corresponding to the maximum value of S₁, S₂, and S₃ is determined as the most suitable model and used.

Specific application of the auto-sorting model 1: A gaming scene is detected on Windows smart terminals.

This scenario involves three models: a pre-trained few-shot player behavior model M1, a proxy model for learning a player's own behavior M2, and a big data model for collecting all player behaviors M3.

Invite game enthusiasts and use few-shot learning to learn player behavior and build a few-shot player behavior model. Collect player proxy data to build a proxy model. Collect all player big data and train a big data model. Multiplayer mode online matching. Use cameras or ultrasounds to locate a player's position. When the player leaves, the online mode automatically derives the appropriate simulated player behavior based on the auto-sorting model. In the single-player mode, the game is paused and the game is resumed after the player returns.

Specific application of the auto-sorting model 2: Intelligent assistant for office or learning scenarios on Windows smart terminals.

This scenario also involves three models: a small local pre-trained model M1 (trained using data from some users), a medium local pre-trained model M2 (trained using M1 data and user A's data), and a large cloud-based continuously trained model M3 (trained using all users' data).

When the local intelligent assistant uses the small model M1, the corresponding P2, P4, and P5 are not much different from other models (that is, the assistant has a good performance). At this time, P1 and P3 have obvious advantages, with low memory usage, fast loading speed, and easier parameter adjustment. According to the auto-sorting model, the S₁ value at this time is the highest, so the small model M1 is automatically selected. However, when the differences between P2, P4, and P5 of the M1 model and the other models become larger (i.e., the performance of the assistant becomes worse), the advantages of P1 and P3 are not enough to offset the disadvantages of the other indicators, and the S₁ value will be significantly reduced according to the auto-sorting model. The auto-sorting model will try to switch to the M2 and M3 models. When the local intelligent assistant uses the medium model M2, the corresponding P2, P4, P5 are not much different from M3, and the S₂ value at this time is the highest, so the small model M2 is automatically selected.

When P2, P4, and P5 of the M2 model become more different from those of the M3 model (i.e., the performance of the assistant becomes worse), the advantages of P1 and P3 are not enough to offset the disadvantages of the other indicators, and the S₂ value according to the auto-sorting model will also be significantly reduced. The auto-sorting model will try to switch to the M3 model. It may also be verified through calculation that the S₃ value at this time is the highest.

FIG. 5 is a schematic diagram of a method for using an auto-sorting model provided by the embodiments of the present disclosure, which may be executed by a processor of an electronic device. The method includes Steps S501 to S503, which will be described in conjunction with the steps shown in FIG. 10.

Step S501: In response to a game launched, detect a player's position.

Step S502: When the player leaves, a model corresponding to the maximum Sₖ value in S₁, S₂, and S₃ is used to replace the player.

In some embodiments, S has an initial value, such as S₁=10, S₂=9, S₃=8.

Step S503: During the running of the M1 model, monitor S₁. When S₁ reaches 8.9, switch to the M2 model corresponding to S₂. When monitoring S₂, if S₂ is greater than 8.9, continue to run the M2 model. When the result of running the M2 model is less than 8.9, switch back to the M1 model.

In some embodiments, in scenario 1, the M1 model is a small model M1 trained based on data from a public beta-version server, and is the same for every user. The M1 model is a model built based on internal beta-version players or invited players.

In some embodiments, in scenario 2, the M2 model is trained based on the M1 data and a user's self-data (user A). Similar to using user A's data to train the M1 model, user A's data is relatively small at the beginning, so the M2 model may be distorted. The first training data for the M2 model only has the first data. The second training has the first two sets of data. The M2 model is trained on the basis of the M1 model and combined with user A's data. The more user A plays, the better the performance of the M2 model. At the beginning, due to the lack of data, the M2 model may be distorted.

In some embodiments, in scenario 3, the M3 model is trained by big data in the cloud. Compared with the M1 model, there are more training samples. The M3 model is trained based on the M1 model and combined with the data of all players, and is constantly trained and updated in the cloud.

In some embodiments, the longer the model runs, the more data will be processed and the more complex the data will be. Switching process: In scenario 1, when there is little data (the M1 model is the fastest, the M2 model is slower, and the M3 model is the slowest, the M3 model is the most accurate, the M2 model is less accurate, and the M1 model is most inaccurate), the weights of the speed P1 indicators of the three models will be very close (50, 30, 20). Since there is little data, the accuracy of the processing is relatively high (32, 33, 35), so the weights of the P2 indicators are also close. In scenario 3, there is a lot of data, the weights of the speed are (33, 33, 33), and the accuracy becomes (1, 36, 63).

In the embodiments of the present disclosure, according to the Sₖ values of the three models, the operating model is switched based on the Sₖ value of the operating model and the historical Sₖ values of other models, so that the operating model continues to maintain a high working level, thereby improving the model accuracy and user experience.

Based on the foregoing embodiments, the embodiments of the present disclosure provide an operation control device, which includes the units and the modules included therein, which may be implemented by a processor in an electronic device. In some embodiments, the modules/units may also be implemented by a specific logic circuit. In the implementation process, the processor may be a central processing unit (CPU), a microprocessor (MPU), a digital signal processor (DSP) or a field programmable gate array (FPGA), etc.

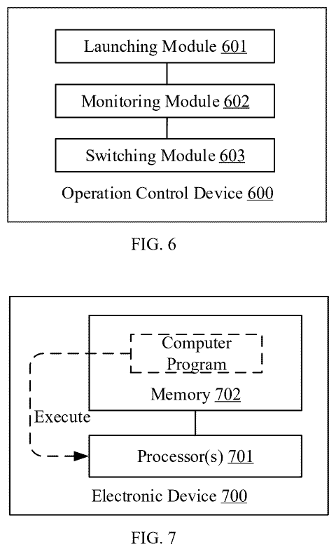

FIG. 6 is a schematic diagram of the system architecture of an operation control device, according to some embodiments of the present disclosure. As shown in FIG. 6, the operation control device 600 includes a launching module 601, a monitoring module 602, and a switching module 603.

The launching module 601 is configured to launch a first target service model in response to a target triggering event during the process of the electronic device running a target application, where the first target service model is configured to provide a target functional service.

The monitoring module 602 is configured to monitor the adaptation value between the first target service model and the target application.

The switching module 603 is configured to control the electronic device to switch from running the first target service model to launching a second target service model when the adaptation value changes to fall within a target threshold range, where the quality of the functional service provided by the second target service model is better than that of the first target service model, and/or the user experience of the second target service model is better than that of the first target service model.

In some embodiments, the launching module 601 is also configured to, in response to a target triggering event, generate a call instruction that matches the target triggering event to launch the first target service model based on the call instruction; in response to a target triggering event, determine and launch the first target service model based on operating parameters of the target application; or in response to a target triggering event, determine and launch the first target service model based on usage information of the electronic device.

In some embodiments, the launching module 601 is also configured to generate a first call instruction in response to a first type of triggering event that triggers the target application to enter a hosting state, so as to launch the corresponding first service model from a first service model set based on the first call instruction; and generate a second call instruction in response to a second type of triggering event that triggers the target application to perform a target task, so as to launch a second service model that matches the target task from a second service model set based on the second call instruction, where the target task comes from the target application or its associated application.

In some embodiments, the launching module 601 is further configured to launch the first service model from the first service model set based on the model identifier carried by the first call instruction; in response to the first call instruction generated based on the first type of triggering event, based on the score of each service model in the first service model set, launch a first service model, from the first service model set, in the target score range; in response to the first call instruction generated based on the first type of triggering event, launch a first service model from the first service model set based on the historical operation data of the target application; in response to the first call instruction generated based on the first type of triggering event, launch a first service model from the first service model set based on the resource usage status of the electronic device; launch a first service model from the first service model set based on the type and/or source of the first triggering event. Here, the first type of triggering event includes at least one of the following: monitoring that the target operator has a first position relationship relative to the electronic device, detecting that no operation command is obtained within a first time period, obtaining a target hosting command, and obtaining an instruction to switch the target application to background operation.

In some embodiments, the launching module 601 is further configured to determine and launch a third service model, from a third service model set, that matches the operating stage based on the operating stage of the target application; determine and launch a fourth service model, from a fourth service model set, that matches the operation mode based on the operation mode of the target application; determine and launch a fifth service model, from a fifth service model set, that matches the operating evaluation information based on the operating evaluation information of the target operator for the target application.

Alternatively, determining and launching the first target service model based on the usage information of the electronic device includes at least one of the following: based on the function and resource usage information of the electronic device, determine and launch a sixth service model, from a sixth service model set, that matches the function and resource usage information; based on the user information of the electronic device, determine and launch a seventh service model, from a seventh service model set, that matches the user information; based on the model usage information of the electronic device, determine and launch an eighth service model, from an eighth service model set, that matches the model usage information; or based on the operating mode information of the electronic device, determine and launch a ninth service model, from a ninth service model set, that matches the operating mode information.

In some embodiments, the monitoring module 602 is also configured to monitor the usage parameters of the first target service model in real time, and calculate the adaptation value of the first target service model based on the usage parameters as the adaptation value between the target application and the first target service model, where the usage parameters are indicator parameters that may indicate the user experience of the first target service model; monitor the interaction data between the target operator and the first target service model in real time, and calculate the adaptation value between the first target service model and the target application based on the interaction data.

In some embodiments, the switching module 603 is also configured to control the electronic device to switch from running the first target service model to launching the second target service model when the adaptation value changes to fall within a first threshold range, where the first threshold range may cause the order of the second target service model in the target service model set where the first target service model is located to change to the first order; and to control the electronic device to switch from running the first target service model to launching the second target service model when the adaptation value changes to fall within a second threshold range, where the second threshold range is the adaptation value range of the second target service model in the target service model set where the first target service model is located.

In some embodiments, the switching module 603 is also configured to control the electronic device to switch from running the second target service model to launching the first target service model or the third target service model when it is detected that the adaptation value of the second target service model changes to fall within a third threshold range; where the third threshold range may cause the order of the first target service model or the third target service model in the target service model set to change to the first order.

In some embodiments, the switching module 603 is also configured to obtain usage parameter change information of the first target service model, and determine a tenth service model, from the target service model set where the first target service model is located, as the second target service model based on the usage parameter change information, so that the electronic device switches from running the first target service model to launching the tenth service model; based on the interaction data between the target operator and the first target service model and the usage parameter change information of the first target service model, determine an eleventh service model from the target service model set as the second target service model, so that the electronic device switches from running the first target service model to launching the eleventh service model.

The description of the above device embodiments is similar to the description of the above method embodiments, and has similar beneficial effects as the method embodiments. In some embodiments, the functions or modules included in the device provided in the embodiments of the present disclosure may be configured to execute the methods described in the above method embodiments. For technical details not disclosed in the device embodiments of the present disclosure, refer to the description of the method embodiments of the present disclosure for understanding.

It should be noted that in the embodiments of the present disclosure, if the above method is implemented in the form of a software function module and sold or used as an independent product, it may also be stored in a computer-readable storage medium. Based on this understanding, the technical solutions of the embodiments of the present disclosure may be essentially or partly reflected in the form of a software product that contributes to the relevant technology. The software product is stored in a storage medium, including several instructions to launch an electronic device (which may be a personal computer, a server, or a network device, etc.) to execute all or part of the methods described in each embodiment of the present disclosure. The aforementioned storage medium includes various media that may store program codes, such as a U disk, a mobile hard disk, a read-only memory (ROM), a magnetic disk or an optical disk. In this way, the embodiments of the present disclosure are not limited to any specific hardware, software or firmware, or any combination of hardware, software, and firmware.

Embodiments of the present disclosure provide an electronic device, including a memory and a processor, where the memory stores a computer program that may be run on the processor, and when the processor executes the program, some or all of the steps in the above methods are implemented.

Embodiments of the present disclosure provide a computer-readable storage medium on which a computer program is stored, and when the computer program is executed by a processor, some or all of the steps in the above methods are implemented. The computer-readable storage medium may be transient or non-transient.

Embodiments of the present disclosure provide a computer program, including a computer-readable code. When the computer-readable code is run in an electronic device, a processor in the electronic device executes some or all of the steps for implementing the above methods.

Embodiments of the present disclosure provide a computer program product, which includes a non-transitory computer-readable storage medium storing a computer program, and when the computer program is read and executed by a computer, some or all of the steps in the above methods are implemented. The computer program product may be implemented in hardware, software, or a combination thereof. In some embodiments, the computer program product is specifically embodied as a computer storage medium, and in other embodiments, the computer program product is specifically embodied as a software product, such as a software development kit (SDK), etc.

It should be noted here that the description of the various embodiments above tends to emphasize the differences between the various embodiments, and the same or similar aspects may be referenced to each other. The description of the above device, storage medium, computer program and computer program product embodiments is similar to the description of the above method embodiments, and has similar beneficial effects as the method embodiments. For technical details not disclosed in the embodiments of the device, storage medium, computer program and computer program product of the present disclosure, refer to the description of the method embodiments of the present disclosure for understanding.

FIG. 7 is a schematic diagram of the system architecture of an electronic device, according to some embodiments of the present disclosure. As shown in FIG. 7, the hardware entity of the electronic device 700 includes a processor 701 and a memory 702, where the memory 702 stores a computer program that may be run on the processor 701, and when the processor 701 executes the program, the steps in the methods of any of the above embodiments are implemented.

The memory 702 stores a computer program that may be run on the processor. The memory 702 is configured to store instructions and applications executable by the processor 701. The memory may also cache data to be processed or executed by the processor 701 and various modules in the electronic device 700 (e.g., image data, audio data, voice communication data, and video communication data). This may be achieved through flash memory or random access memory (RAM).

When the processor 701 executes the program, the steps of any of the above methods are implemented. The processor 701 generally controls the overall operation of the electronic device 700.

Embodiments of the present disclosure provide a computer storage medium, which stores one or more programs. The one or more programs may be executed by one or more processors to implement the steps of the methods of any of the above embodiments.

It should be noted here that the description of the above storage medium and device embodiments is similar to the description of the above method embodiments, and has similar beneficial effects as the method embodiments. For technical details not disclosed in the storage medium and device embodiments of the present disclosure, refer to the description of the method embodiments of the present disclosure for understanding.

The processor may be at least one of an application specific integrated circuit (ASIC), a digital signal processor (DSP), a digital signal processing device (DSPD), a programmable logic device (PLD), a field programmable gate array (FPGA), a central processing unit (CPU), a controller, a microcontroller, and a microprocessor. It is understandable that the electronic device that implements the functions of the processor may also be others, which the embodiments of the present disclosure do not specifically limit.

The computer storage medium/memory may be a read-only memory (ROM), a programmable read-only memory (PROM), an erasable programmable read-only memory (EPROM), an electrically erasable programmable read-only memory (EEPROM), a magnetic random access memory (FRAM), a flash memory, a magnetic surface memory, an optical disk, or a compact disc read-only memory (CD-ROM) and the like. It may also be various terminals including one or any combination of the foregoing memories, such as mobile phones, computers, tablet devices, personal digital assistants, etc.

It should be understood that “one embodiment” or “an embodiment” mentioned throughout the specification means that specific features, structures or characteristics related to the embodiment are included in at least one embodiment of the present disclosure. Therefore, “in one embodiment” or “in an embodiment” appearing throughout the specification does not necessarily refer to the same embodiment. In addition, these specific features, structures or characteristics may be combined in one or more embodiments in any suitable manner. It should be understood that in various embodiments of the present disclosure, the value of the serial number of each step/process mentioned above does not mean the order of execution, and the execution order of each step/process should be determined by its function and internal logic, and should not constitute any limitation on the implementation process of the embodiments of the present disclosure. The serial numbers of the embodiments of the present disclosure mentioned above are for description only and do not indicate the advantages and disadvantages of the embodiments.

It should be noted that, in this disclosure, the terms “include”, “comprises” or any other variations thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “comprises a . . . ” does not exclude the existence of other identical elements in the process, method, article or device including the element.

In the specific embodiments provided in the present disclosure, it should be understood that the disclosed devices and methods may be implemented in other ways. The device embodiments described above are merely schematic. For example, the division of the units is merely a logical function division. There may be other division methods in actual implementation, such as multiple units or components may be combined, or may be integrated into another system, or some features may be ignored or not executed. In addition, the coupling, direct coupling, or communication connection between the components shown or discussed may be through some interfaces, and the indirect coupling or communication connection of the devices or units may be electrical, mechanical or other forms.

The units described above as separate components may or may not be physically separated, and the components displayed as units may or may not be physical units. These units may be located in one place or distributed on multiple network units. Some or all of the units may be selected according to actual needs to achieve the purpose of the present disclosure.

In addition, all functional units in the embodiments of the present disclosure may be integrated into one processing unit, or each unit may be used as a separate unit, or two or more units may be integrated into one unit. The integrated unit may be implemented in the form of hardware or in the form of hardware plus software functional units. A person of ordinary skill in the art may understand that all or part of the steps of the above method embodiments may be completed by hardware related to program instructions, and the above program may be stored in a computer-readable storage medium. When the program is executed, the steps of the above method embodiments are executed. The above storage medium includes mobile storage devices, ROM, disks or optical disks, and various other media that may store program codes.

Alternatively, if the foregoing integrated unit of the present disclosure is implemented in the form of a software function module and sold or used as an independent product, it may also be stored in a computer-readable storage medium. Based on this understanding, the technical solutions of the present disclosure may essentially or in other words, the part that contributes to the relevant technology may be embodied in the form of a software product, and the computer software product is stored in a storage medium, including a number of instructions for an electronic device (which may be a personal computer, server, or network device, etc.) to execute all or part of the methods described in each embodiment of the present disclosure. The aforementioned storage medium includes various media that may store program codes, such as mobile storage devices, ROMs, magnetic disks, or optical disks.

The foregoing describes merely some implementation methods of the present disclosure, but the protection scope of the present disclosure is not limited thereto. Any technician familiar with the technical field may easily think of changes or substitutions within the technical scope disclosed in the present disclosure, which should fall within the protection scope of the present disclosure.

What is claimed is:

1. An operation control method, comprising:
in a process of an electronic device running a target application, in response to a target triggering event, launching a first target service model, wherein the first target service model is configured to provide a target functional service;
monitoring an adaptation value between the first target service model and the target application; and
when the adaptation value changes to fall within a target threshold range, controlling the electronic device to switch from running the first target service model to launching a second target service model, wherein a quality of a functional service provided by the second target service model is better than a quality of a functional service provided by the first target service model, and/or a user experience of the second target service model is better than a user experience of the first target service model.

2. The method according to claim 1, wherein launching the first target service model comprises at least one of following:
in response to the target triggering event, generating a call instruction matching the target triggering event to launch the first target service model based on the call instruction;
in response to the target triggering event, determining and launching the first target service model based on operating parameters of the target application; or
in response to the target triggering event, determining and launching the first target service model based on usage information of the electronic device.

3. The method according to claim 2, wherein generating the call instruction matching the target triggering event to launch the first target service model based on the call instruction comprises at least one of following:
in response to a first type of triggering event that triggers the target application to enter a hosting state, generating a first call instruction to launch a corresponding first service model from a first service model set based on the first call instruction; or
in response to a second type of triggering event that triggers the target application to execute a target task, generating a second call instruction to launch a second service model, that matches the target task, from a second service model set based on the second call instruction, wherein the target task comes from the target application or its associated application.

4. The method according to claim 3, wherein launching the corresponding first service model from the first service model set based on the first call instruction comprises at least one of following:
launching the first service model from the first service model set based on a model identifier carried by the first call instruction;
in response to the first call instruction generated based on the first type of triggering event, based on a score of each service model in the first service model set, launching the first service model, in a target score range, from the first service model set;
in response to the first call instruction generated based on the first type of triggering event, launching the first service model from the first service model set based on historical operating data of the target application;
in response to the first call instruction generated based on the first type of triggering event, launching the first service model from the first service model set based on a resource status of the electronic device; or
launching the first service model from the first service model set based on a type and/or source of the first type of triggering event,
wherein the first type of triggering event includes at least one of the following: detecting that a target operator has a first position relationship with the electronic device, detecting that no operation command is obtained within a first time period, obtaining a target hosting command, and obtaining an instruction to switch the target application to a background operation.

5. The method according to claim 2, wherein determining and launching the first target service model based on the operating parameters of the target application comprises at least one of following:
determining and launching a third service model, from a third service model set, that matches an operating stage based on the operating stage of the target application;
determining and launching a fourth service model, from a fourth service model set, that matches an operation mode based on the operation mode of the target application; or
determining and launching a fifth service model, from a fifth service model set, that matches operation evaluation information based on the operation evaluation information of a target operator for the target application.

6. The method according to claim 2, wherein determining and launching the first target service model based on the usage information of the electronic device includes at least one of following:
determining and launching a sixth service model, from a sixth service model set, that matches function and resource usage information based on the function and resource usage information of the electronic device;
determining and launching a seventh service model, from a seventh service model set, that matches user information based on the user information of the electronic device;
determining and launching an eighth service model, from an eighth service model set, that matches model usage information based on the model usage information of the electronic device; or
determining and launching a ninth service model, from a ninth service model set, that matches operating mode information based on the operating mode information of the electronic device.

7. The method according to claim 1, wherein monitoring the adaptation value between the first target service model and the target application comprises at least one of following:
monitoring usage parameters of the first target service model in real time, and calculating an adaptation value of the first target service model based on the usage parameters as the adaptation value between the first target service model and the target application, wherein the usage parameters are indicator parameters that indicate the user experience of the first target service model; or
monitoring interaction data between a target operator and the first target service model in real time, and calculating the adaptation value between the first target service model and the target application based on the interaction data.

8. The method according to claim 1, wherein controlling the electronic device to switch from running the first target service model to launching the second target service model comprises at least one of following:
when the adaptation value changes to fall within a first threshold range, controlling the electronic device to switch from running the first target service model to launching the second target service model, wherein the first threshold range is able to cause an order of the second target service model in a target service model set where the first target service model is located to change to a first order; or
when the adaptation value changes to fall within a second threshold range, controlling the electronic device to switch from running the first target service model to launching the second target service model, wherein the second threshold range is an adaptation value range of the second target service model in the target service model set where the first target service model is located.

9. The method according to claim 8, further comprising:
when it is detected that the adaptation value of the second target service model changes to fall within a third threshold range, controlling the electronic device to switch from running the second target service model to launching the first target service model or a third target service model,
wherein the third threshold range may cause an order of the first target service model or the third target service model in the target service model set to change to the first order.

10. The method according to claim 8, further comprising at least one of following:
obtaining usage parameter change information of the first target service model, and determining a tenth service model from the target service model set where the first target service model is located as the second target service model based on the usage parameter change information, so that the electronic device switches from running the first target service model to launching the tenth service model; or
based on interaction data between a target operator and the first target service model and the usage parameter change information of the first target service model, determining an eleventh service model from the target service model set as the second target service model, so that the electronic device switches from running the first target service model to launching the eleventh service model.

11. An electronic device, comprising one or more processors and a memory containing a computer program that, when being executed, causes the one or more processors to perform:
in a process of the electronic device running a target application, in response to a target triggering event, launching a first target service model, wherein the first target service model is configured to provide a target functional service;
monitoring an adaptation value between the first target service model and the target application; and
when the adaptation value changes to fall within a target threshold range, controlling the electronic device to switch from running the first target service model to launching a second target service model, wherein a quality of a functional service provided by the second target service model is better than a quality of a functional service provided by the first target service model, and/or a user experience of the second target service model is better than a user experience of the first target service model.

12. The device according to claim 11, wherein the one or more processors are further configured to perform at least one of following:
in response to the target triggering event, generating a call instruction matching the target triggering event to launch the first target service model based on the call instruction;
in response to the target triggering event, determining and launching the first target service model based on operating parameters of the target application; or
in response to the target triggering event, determining and launching the first target service model based on usage information of the electronic device.

13. The device according to claim 12, wherein the one or more processors are further configured to perform at least one of following:
in response to a first type of triggering event that triggers the target application to enter a hosting state, generating a first call instruction to launch a corresponding first service model from a first service model set based on the first call instruction; or
in response to a second type of triggering event that triggers the target application to execute a target task, generating a second call instruction to launch a second service model, that matches the target task, from a second service model set based on the second call instruction, wherein the target task comes from the target application or its associated application.

14. The device according to claim 13, wherein the one or more processors are further configured to perform at least one of following:
launching the first service model from the first service model set based on a model identifier carried by the first call instruction;
in response to the first call instruction generated based on the first type of triggering event, based on a score of each service model in the first service model set, launching the first service model, in a target score range, from the first service model set;
in response to the first call instruction generated based on the first type of triggering event, launching the first service model from the first service model set based on historical operating data of the target application;
in response to the first call instruction generated based on the first type of triggering event, launching the first service model from the first service model set based on a resource status of the electronic device; or
launching the first service model from the first service model set based on a type and/or source of the first type of triggering event,
wherein the first type of triggering event includes at least one of the following: detecting that a target operator has a first position relationship with the electronic device, detecting that no operation command is obtained within a first time period, obtaining a target hosting command, and obtaining an instruction to switch the target application to a background operation.

15. The device according to claim 12, wherein the one or more processors are further configured to perform at least one of following:
determining and launching a third service model, from a third service model set, that matches an operating stage based on the operating stage of the target application;
determining and launching a fourth service model, from a fourth service model set, that matches an operation mode based on the operation mode of the target application; or
determining and launching a fifth service model, from a fifth service model set, that matches operation evaluation information based on the operation evaluation information of a target operator for the target application.

16. The device according to claim 12, wherein the one or more processors are further configured to perform at least one of following:
determining and launching a sixth service model, from a sixth service model set, that matches function and resource usage information based on the function and resource usage information of the electronic device;
determining and launching a seventh service model, from a seventh service model set, that matches user information based on the user information of the electronic device;
determining and launching an eighth service model, from an eighth service model set, that matches model usage information based on the model usage information of the electronic device; or
determining and launching a ninth service model, from a ninth service model set, that matches operating mode information based on the operating mode information of the electronic device.

17. The device according to claim 11, wherein the one or more processors are further configured to perform at least one of following:
monitoring usage parameters of the first target service model in real time, and calculating an adaptation value of the first target service model based on the usage parameters as the adaptation value between the first target service model and the target application, wherein the usage parameters are indicator parameters that indicate the user experience of the first target service model; or
monitoring interaction data between a target operator and the first target service model in real time, and calculating the adaptation value between the first target service model and the target application based on the interaction data.

18. The device according to claim 11, wherein the one or more processors are further configured to perform at least one of following:
when the adaptation value changes to fall within a first threshold range, controlling the electronic device to switch from running the first target service model to launching the second target service model, wherein the first threshold range is able to cause an order of the second target service model in a target service model set where the first target service model is located to change to a first order; or
when the adaptation value changes to fall within a second threshold range, controlling the electronic device to switch from running the first target service model to launching the second target service model, wherein the second threshold range is an adaptation value range of the second target service model in the target service model set where the first target service model is located.

19. The device according to claim 18, wherein the one or more processors are further configured to perform:
when it is detected that the adaptation value of the second target service model changes to fall within a third threshold range, controlling the electronic device to switch from running the second target service model to launching the first target service model or a third target service model,
wherein the third threshold range may cause an order of the first target service model or the third target service model in the target service model set to change to the first order.

20. A non-transitory computer readable storage medium containing a computer program that, when being executed, causes at least one processor to perform:
in a process of an electronic device running a target application, in response to a target triggering event, launching a first target service model, wherein the first target service model is configured to provide a target functional service;
monitoring an adaptation value between the first target service model and the target application; and
when the adaptation value changes to fall within a target threshold range, controlling the electronic device to switch from running the first target service model to launching a second target service model, wherein a quality of a functional service provided by the second target service model is better than a quality of a functional service provided by the first target service model, and/or a user experience of the second target service model is better than a user experience of the first target service model.
